(19) United States
(12) Patent Application Publication
(10) Pub. No.: US 2012/0044852 A1
(43) Pub. Date: Feb. 23, 2012

(54) Resource Scheduling Method and System, Base Station and Relay Node

(75) Inventors: Wenjian Zhang, Beijing (CN); Xueming Pan, Beijing (CN); Zukang Shen, Beijing (CN); Guojun Xiao, Beijing (CN); Libo Wang, Beijing (CN)

(73) Assignee: CHINA ACADEMY OF TELECOMMUNICATIONS TECHNOLOGY

(21) Appl. No.: 13/275,285

(22) Filed: Oct. 17, 2011

Related U.S. Application Data
(63) Continuation of application No. PCT/CN2010/071864, filed on Apr. 19, 2010.

(30) Foreign Application Priority Data
Apr. 17, 2009 (CN) 200910082030.0
Apr. 20, 2009 (CN) 200910082260.7

(51) Int. Cl. H04W 72/04; H04W 74/04; H04B 7/14; H04H 20/71

(52) U.S. Cl. 370/312; 370/315

(57) ABSTRACT

The present invention discloses a resource scheduling method and system, a BS and a RN, which include that: the BS allocates an uplink subframe for performing uplink transmission of a backhaul link and a downlink subframe for performing downlink transmission of the backhaul link, and informs the RN of the allocation information of the uplink subframe and the downlink subframe of the backhaul link, or the BS only informs the RN of the allocation information of the uplink subframe or the downlink subframe of the backhaul link; the RN may determine, according to the received allocation information and a predefined timing relationship, an uplink subframe and a downlink subframe of the backhaul link of which the BS does not inform. By the solution of the present invention, an MBSFN subframe can be indicated to the RN, and uplink transmission conflict can be avoided.

### FIELD OF THE INVENTION

The present invention relates to mobile communication technologies, and more particularly to a resource scheduling method and system, a Base Station (BS) and a Relay Node (RN).

### BACKGROUND OF THE INVENTION

The application of Relay Node (RN) makes a Relay based mobile communication system have three radio links, i.e., an eNB-macro UE direct link, an eNB-RN backhaul link, and a RN-relay UE access link, which are respectively called a direct link, a backhaul link and an access link for short. The transceiver of the RN adopts a Time Division Dual (TDD) mode, i.e., in the TDD mode, the receiving and transmitting can not be performed at the same time.

The backhaul link and the access link may use the same frequency, but the transmitter of the RN interferes with the receiver of the RN unless signals received by the receiver are completely separated from signals transmitted by the transmitter. And thus, a downlink backhaul link and a downlink access link usually can not use the same frequency resources at the same time, and an uplink backhaul link and an uplink access link also can not use the same frequency resources at the same time. In order to avoid the interference, a following processing mode is usually adopted in the prior art. If the RN receives data from a BS (which is also called as an eNB), the RN does not transmit data to a User Equipment (UE), i.e., a “gap” is created by using a Multicast/Broadcast over a Single Frequency Network (MBSFN) subframe in the transmission time of the downlink access link. FIG. 1 is a schematic diagram illustrating a procedure of performing downlink transmission of a relay link by using a MBFSN subframe in the prior art. As shown in FIG. 1, in the “gap”, the RN only receives data from the eNB, but does not transmit data to the UE; the “Ctrl” is used for transmitting control signaling to the UE by the RN, i.e., used for performing scheduling for the UE.

The mode shown in FIG. 1 solves the interference problem, but results in a new problem, which will be illustrated hereinafter.

FIG. 2 is a schematic diagram illustrating a conventional resource scheduling mode. As shown in FIG. 2, in a subframe n, a UE receives Downlink Control Information (DCI) sent by a RN through a Physical Downlink Control Channel (PDCCH), where the DCI contains uplink scheduling information that the RN schedules the UE to perform uplink data transmission in a subfram n+k. Correspondingly, the UE transmits uplink data to the RN in the subframe n+k through a Physical Uplink Shared Channel (PUSCH). After transmitting the DCI to the UE, the RN receives a DCI sent by the eNB through a Relay Physical Downlink Control Channel (R-PDCCH), where the DCI received by the RN contains uplink scheduling information that the eNB schedules the RN to perform uplink data transmission in the subframe n+k. Correspondingly, the RN transmits uplink data in the subframe n+k through a Relay Physical Uplink Shared Channel (R-PUSCH). Since the uplink data transmission of the backhaul link or the access link is performed in the whole subframe, in the same subframe, the RN performs a transmission operation for the eNB, and also performs a receiving operation for the UE, which results in uplink transmission conflict.

In addition, though the mode shown in FIG. 1 can solve the interference problem, it is unclear in the prior art that how the RN learns which subframe will be taken as a MBSFN subframe. Therefore, the RN can not learn when to receive the R-PDCCH containing the uplink scheduling information sent by the eNB, further it can not be determined when uplink transmission conflict occurs, and thus the uplink transmission conflict can not be solved.

### SUMMARY OF THE INVENTION

Examples of the present invention provide a resource scheduling method and system, a BS and a RN, by which a MBSFN subframe can be indicated to the RN, and uplink transmission conflict can be avoided.

In order to achieve the above object, the technical solution of the present invention is implemented as follows.

A resource scheduling method includes:

allocating, by a Base Station (BS), an uplink subframe for performing uplink transmission of a backhaul link and a downlink subframe for performing downlink transmission of the backhaul link, and informing a Relay Node (RN) of allocation information of the uplink subframe and the downlink frame of the backhaul link, so that the RN disable scheduling a User Equipment (UE) served by the RN to perform uplink data transmission in the uplink subframe of the backhaul link and configures the downlink subframe of the backhaul link as a Multicast/Broadcast over a Single Frequency Network (MBSFN) subframe.

A resource scheduling method includes:

receiving, by a Relay Node (RN), allocation information of an uplink subframe for performing uplink transmission of a backhaul link and a downlink subframe for performing downlink transmission of the backhaul link from a Base Station (BS);

determining, location of the uplink subframe and the downlink subframe of the backhaul link according to the allocation information; and

configuring the downlink subframe of the backhaul link as a Multicast/Broadcast over a Single Frequency Network (MBSFN) subframe, and disabling scheduling a User Equipment (UE) served by the RN to perform uplink data transmission in the uplink subframe of the backhaul link.

A Base Station (BS) includes:

a first allocating unit, configured to allocate an uplink subframe for performing uplink transmission of a backhaul link and a downlink subframe for performing downlink transmission of the backhaul link;

a first informing unit, configured to inform a Relay Node (RN) of allocation information of the uplink subframe and the downlink subframe of the backhaul link, so that the RN disables scheduling a User Equipment (UE) served by the RN to perform uplink data transmission in the uplink subframe of the backhaul link, and configures the downlink subframe of the backhaul link as a Multicast/Broadcast over a Single Frequency Network (MBSFN) subframe.

A RN includes:

a first receiving unit, configured to receive allocation information of an uplink subframe for performing uplink transmission of a backhaul link and a downlink subframe for performing uplink transmission of the backhaul link from a Base Station (BS);

a first determining unit, configured to determine location of the uplink subframe and the downlink subframe of the backhaul link according to the received allocation information; and

a first controlling unit, configured to configure the downlink subframe of the backhaul link as a Multicast/Broadcast over a Single Frequency Network (MBSFN) subframe, and disable scheduling a User Equipment (UE) served by the RN to perform uplink data transmission in the uplink subframe of the backhaul link.

A resource scheduling method includes:

allocating, by a Base Station (BS), an uplink subframe for performing uplink transmission of a backhaul link and a downlink subframe for performing downlink transmission of the backhaul link, and informing a Relay Node (RN) of allocation information of the uplink subframe or the downlink frame of the backhaul link, so that the RN determines an downlink subframe and an uplink subframe of the backhaul link of which the BS does not inform.

A resource scheduling method includes:

receiving, by a Relay Node (RN), allocation information of an uplink subframe for performing uplink transmission of a backhaul link or a downlink subframe for performing downlink transmission of the backhaul link from a Base Station (BS), and determining, location of the uplink subframe or the downlink subframe of the backhaul link according to the allocation information;

determining, by the RN, according to the determined uplink subframe or the downlink subframe of the backhaul link and a predefined timing relationship, an uplink subframe or a downlink subframe of the backhaul link of the BS does not inform.

A Base Station (BS) includes:

a second allocating unit, configured to allocate an uplink subframe for performing uplink transmission of a backhaul link and a downlink subframe for performing downlink transmission of the backhaul link;

a second informing unit, configured to inform a Relay Node (RN) of allocation information of the uplink subframe or the downlink frame of the backhaul link, so that the RN determines, according to a predefined timing relationship, an uplink subframe or a downlink subframe of the backhaul link of which the BS does not inform.

A RN includes:

a second receiving unit, configured to receive allocation information of an uplink subframe or a downlink frame of a backhaul link from a Base Station (BS);

a second determining unit, configured to determine location of the uplink subframe or the downlink subframe of the backhaul link according to the allocation information, and determine, according to a predefined timing relationship, a downlink subframe or an uplink subframe of the backhaul link of which the BS does not inform.

As can be seen, in the technical solution of the present invention, the eNB informs the RN of the allocated uplink subframe for performing uplink transmission of the backhaul link and the allocated downlink subframe for performing downlink transmission of the backhaul link. In this way, the RN may configure the downlink subframe of the backhaul link as a MBSFN subframe in a subsequent procedure, and disables scheduling the UE served by the RN to perform uplink data transmission in the uplink subframe of the backhaul link, so as to avoid uplink transmission conflict.

Further, in the technical solution of the present invention, the eNB may only inform the RN of the allocated uplink subframe for performing uplink transmission of the backhaul link or the allocated downlink subframe for performing downlink transmission of the backhaul link, and then the RN may self-determine, according to the received informing message and the predefined timing relationship, a downlink subframe for performing downlink transmission of the backhaul link or an uplink subframe for performing uplink transmission of the backhaul link of which the eNB does not inform. In this way, the eNB does not need to inform the RN of the allocated uplink subframe and downlink subframe, so as to decrease signaling overhead.

### BRIEF DESCRIPTION OF THE DRAWINGS

The schematic examples of the present invention will be illustrated hereinafter in detail with reference to the accompany drawings, so as to make those skilled in the art understand the above and other features and merits of the present invention clearly. In the drawings:

FIG. 1 is a schematic diagram illustrating a procedure of performing downlink transmission of a relay link by using a MBFSN subframe in the prior art.

FIG. 2 is a schematic diagram illustrating a conventional resource scheduling mode.

FIG. 3 is a schematic flowchart illustrating a resource scheduling method according to a first example of the present invention.

FIG. 4 is a schematic diagram illustrating the structure of a resource scheduling system according to the first example of the present invention.

FIG. 5 is a schematic diagram illustrating the structure of an eNB according to the first example of the present invention.

FIG. 6 is a schematic diagram illustrating the structure of a RN according to the first example of the present invention.

FIG. 7 is a schematic flowchart illustrating a resource scheduling method according to a second example of the present invention.

FIG. 8 is a schematic diagram illustrating the structure of an eNB according to the second example of the present invention.

FIG. 9 is a schematic diagram illustrating the structure of a RN according to the second example of the present invention.

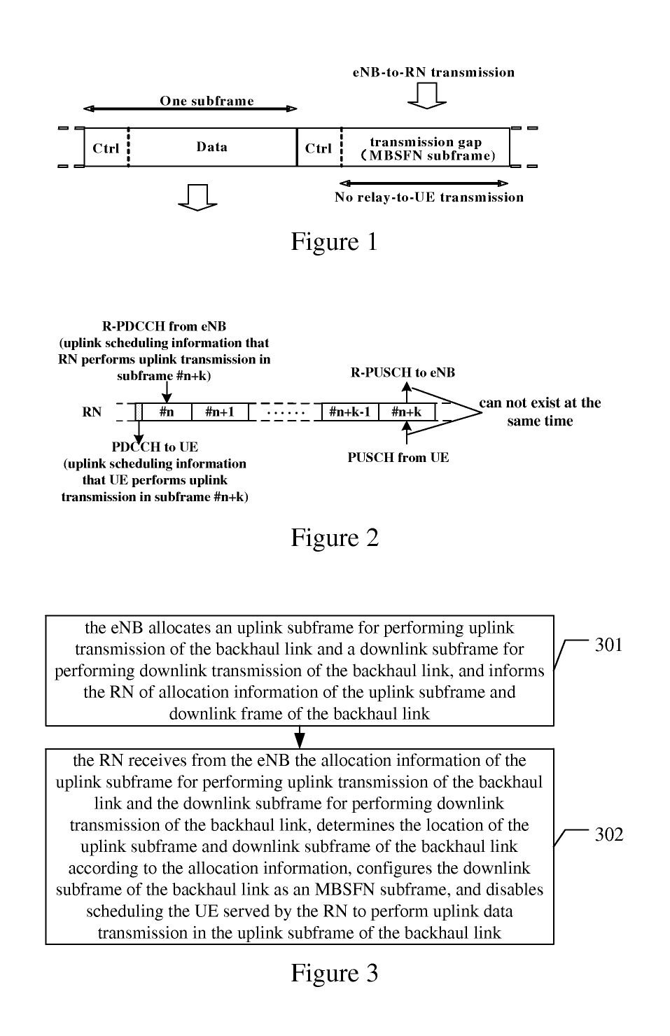

### DETAILED DESCRIPTION OF THE INVENTION

In order to solve the problem in the prior art, the examples of the present invention provide a new resource scheduling method, which includes that: when a RN begins to access a network and does not perform actual communication, an eNB informs the RN of an allocated uplink subframe for performing uplink transmission of a backhaul link and an allocated downlink subframe for performing downlink transmission of the backhaul link, and the RN disables scheduling a UE served by the RN to perform uplink data transmission in the uplink subframe of the backhaul link, and configures the downlink subframe of the backhaul link as a MBSFN subframe.

In practical applications, the eNB may inform the RN of the uplink subframe for performing uplink transmission of the backhaul link and the downlink subframe for performing downlink transmission of the backhaul link, or only inform the RN of the uplink subframe for performing uplink transmission of the backhaul link or the downlink subframe for performing downlink transmission of the backhaul link. The RN determines, according to the uplink subframe of the backhaul link or the downlink subframe of the backhaul link of which the eNB informs and a predefined timing relationship, a downlink subframe or uplink subframe of the backhaul link of which the eNB does not inform.

The present invention will be described in detail hereinafter with reference to accompanying drawings and examples to make the object, technical solution and merits of the present invention clearer.

FIG. 3 is a schematic flowchart illustrating a resource scheduling method according to a first example of the present invention. In this example, it is supposed that the eNB informs the RN of the allocated uplink subframe and downlink subframe of the backhaul link. As shown in FIG. 3, the method includes the following steps.

Step 301: the eNB allocates an uplink subframe for performing uplink transmission of the backhaul link and a downlink subframe for performing downlink transmission of the backhaul link, and informs the RN of allocation information of the uplink subframe and downlink frame of the backhaul link.

In this step, it is a conventional technology that how the eNB allocates the uplink subframe for performing uplink transmission of the backhaul link and the downlink subframe for performing downlink transmission of the backhaul link, and will not be described in detail. The mode of informing the RN will be described hereinafter in detail.

One mode of informing the RN includes directly informing the RN of location information of the uplink subframe of the backhaul link and location information of the downlink subframe of the backhaul link. In the prior art, a perfect MBSFN subframe informing mode has been provided, but not applied between the eNB and the RN. The MBSFN subframe informing mode is a bitmap mode, and includes two cases.

A) Bitmap that covers one radio frame BIT STRING (SIZE(6))

B) Bitmap that covers four continuous radio frames BIT STRING (SIZE(24))

The bitmap mode may be used to inform the RN of the location of the uplink subframe of the backhaul link and the location of the downlink subframe of the backhaul link.

In a system adopting a Frequency Division Dual (FDD) mode, since an uplink operation and a downlink operation are performed in different frequency bands, two bitmaps are needed to inform the RN of the location of the uplink subframe of the backhaul link and the location of the downlink subframe of the backhaul link. In each radio frame, downlink subframes 0, 4, 5 and 9 are used to transmit synchronous signals and broadcast messages, thus can not be configured as MBSFN subframes and can not be used to transmit downlink data of the backhaul link. If the mode A) is adopted, the downlink subframe of the backhaul link is indicated by 6 bits. Since the allocation of the uplink subframe of the backhaul link is not limited, 10 bits are needed to indicate the uplink subframe of the backhaul link, and each bit corresponds to 0 or 1. When the corresponding subframe is a subframe of the backhaul link, the corresponding bit is configured as 1.

In a system adopting a TDD mode, since an uplink operation and a downlink operation are performed in the same frequency band, the uplink subframe and downlink subframe of the backhaul link may be indicated by a uniform bitmap. Since the subframes 0, 1, 5 and 6 can not be configured as MBSFN subframes, in the single radio frame, the uplink subframe and downlink subframe of the backhaul link may be indicated by 6 bits.

In this example, through the conventional informing modes, the eNB may inform the RN of the allocated uplink subframe for performing uplink transmission of the backhaul link and the allocated downlink subframe for performing downlink transmission of the backhaul link.

Another informing mode is as follows. If the allocated subframes of the backhaul link are a subset of a predefined subframe allocation set, the eNB informs the RN of an index value of the subframes of the backhaul linke in the subframe allocation set. For example, for a certain TDD configuration, different subframe allocation may be predefined according to the proportion of different subframes, to form the subframe allocation set. If the subframes of the backhaul link allocated by the eNB are one kind of subframes in the subframe allocation set, it is only needed to inform the RN of the index value of the subframes of the backhaul linke in the subframe allocation set. The RN may determine the allocated subframes of the backhaul link according to a prestored subframe allocation set. The example will be illustrated hereinafter by taking a TDD configuration 1 as an example.

For the TDD configuration 1, according to the allocation proportion and location of different subframes, there are five modes for allocating the subframes of the backhaul link, so as to form the predefined subframe allocation set.

A first allocation mode: an uplink subframe 3 and a downlink subframe 9 are allocated as the subframes of the backhaul link.

A second allocation mode: a downlink subframe 4 and an uplink subframe 8 are allocated as the subframes of the backhaul link.

A third allocation mode: the uplink subframes 3 and 8 and the downlink subframes 4 and 9 are allocated as the subframes of the backhaul link.

A fourth allocation mode: the uplink subframe 3 and the downlink subframes 4 and 9 are allocated as the subframes of the backhaul link.

A fifth allocation mode: the uplink subframe 8 and the downlink subframes 4 and 9 are allocated as the subframes of the backhaul link.

Suppose the index values of the above five allocation modes are 1-5 respectively. If the eNB allocates the downlink subframe 4 and the uplink subrame 8 as the subframes of the backhaul link, the eNB informs the RN of the index value 2. The RN may determine, according to the prestored subframe allocation set, that the downlink subframe 4 and the uplinik subrame 8 are the subframes of the backhaul link.

It should be noted that, the above description is a schematic example, and will change according to different cases.

The eNB may inform the RN of the location or index value of the subframes of the backhaul link through a broadcast message or a higher-layer signaling. When the same subframe is allocated to all RNs in a cell served by the eNB, the eNB may inform the RN through the broadcast message, so save singling overhead. When different subframes are allocated to different RNs, the eNB respectively informs each RN through the higher-layer signaling. The higher-layer signaling includes, but is not limited to, a Radio Resourc Control (RRC) signaling.

In a subsequent procedure, the eNB may reallocate, according to the quality of the backhaul link and the data quantity of the backhaul link to be transmitted, an uplink subframe for performing uplink transmission of the backhaul link and a downlink subframe for performing downlink transmission of the backhaul link to the RN. The reallocation may be triggered by the eNB, or may be triggered by the RN.

A) The reallocation may be triggered by the eNB.

The eNB counts Buffer States Reports (BSRs) which are reported by the RN in a predefined period of time, and adjusts, according to the BSRs, the number of uplink subframes for performing uplink transmission of the backhaul link which are allocated to the RN, i.e., if the buffer state indicates that the quantity of data to be transmitted to the eNB by the RN is large, the eNB increases the number of uplink subframes allocated to the RN; if the buffer state indicates that the quantity of data to be transmitted to the eNB by the RN is small, the eNB decreases the number of uplink subframes allocated to the RN. At the same time, the eNB counts buffer states which are transmitted to the RN by the eNB in a predefined period of time, and adjusts, according to the buffer states, the number of downlink subframes for performing downlink transmission of the backhaul link which is allocated to the RN. The above procedure of adjusting the number of subframes may be taken as a procedure of reallocating the subframes of the backhaul link.

B) The reallocation may be triggered by the RN.

The RN transmits an adjusting request to the eNB according to the BSR which are reported to the eNB by the RN in a predefined period of time, to request to increase or decrease the number of needed subframes. The eNB adjusts, according to the adjusting request, the number of the uplink subframes for performing uplink transmission of the backhaul link which are allocated to the RN. At the same time, the eNB counts buffer states which are transmitted to the RN by the eNB in a predefined period of time, and adjusts, according to the buffer states, the number of the downlink subframes for performing downlink transmission of the backhaul link which are allocated to the RN. The above procedure of adjusting the number of subframes may be taken as a procedure of reallocating the subframes of the backhaul link.

Step 302: the RN receives from the eNB the allocation information of the uplink subframe for performing uplink transmission of the backhaul link and the downlink subframe for performing downlink transmission of the backhaul link, determines the location of the uplink subframe and downlink subframe of the backhaul link according to the allocation information, configures the downlink subframe of the backhaul link as an MBSFN subframe, and disables scheduling the UE served by the RN to perform uplink data transmission in the uplink subframe of the backhaul link.

In this step, after receiving the bitmap or the index value from the eNB, the RN respectively determines the location of the uplink subframe of the backhaul link and the location of the downlink subframe of the backhaul link according to the received information, configures the downlink subframe of the backhaul link as the MBSFN subframe, determines uplink scheduling information in advance according to the determined uplink subframe of the backhaul link, and disables scheduling the UE served by the RN to perform uplink data transmission in the uplink subframe of the backhaul link, so as to avoid uplink transmission conflict.

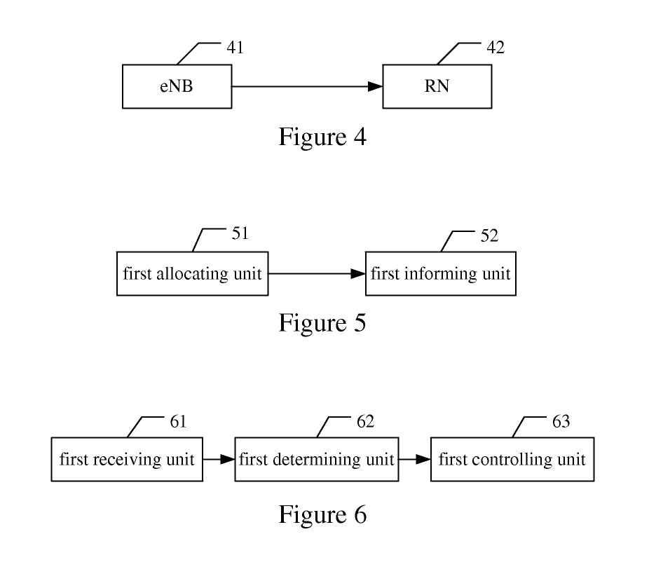

Based on the above method, FIG. 4 is a schematic diagram illustrating the structure of a resource scheduling system according to the first example of the present invention. As shown in FIG. 4, the system includes:

an eNB41, configured to allocate an uplink subframe for performing uplink transmission of a backhaul link and a downlink subframe for performing downlink transmission of the backhaul link, and inform a RN42 of the allocation information of the uplink subframe and downlink subframe of the backhaul link; and

the RN42, configured to receive the allocation information of the uplink subframe and downlink subframe of the backhaul link from the eNB41, determine the location of the uplink subframe and downlink subframe of the backhaul link, configure the downlink subframe of the backhaul link as an MBSFN subframe, and disable scheduling the UE served by the RN to perform uplink data transmission in the uplink subframe of the backhaul link.

FIG. 5 is a schematic diagram illustrating the structure of an eNB according to the first example of the present invention. As shown in FIG. 5, the eNB includes:

a first allocating unit 51, configured to allocate an uplink subframe for performing uplink transmission of a backhaul link and a downlink subframe for performing downlink transmission of the backhaul link;

a first informing unit 52, configured to inform a RN of the allocation information of the uplink subframe and downlink subframe of the backhaul link, so that the RN disables scheduling the UE served by the RN to perform uplink data transmission in the uplink subframe of the backhaul link, and configures the downlink subframe of the backhaul link as an MBSFN subframe.

FIG. 6 is a schematic diagram illustrating the structure of a RN according to the first example of the present invention. As shown in FIG. 6, the RN includes:

a first receiving unit 61, configured to receive allocation information of an uplink subframe for performing uplink transmission of a backhaul link and a downlink subframe for performing downlink transmission of the backhaul link from an eNB;

a first determining unit 62, configured to determine the location of the uplink subframe and downlink subframe of the backhaul link according to the received allocation information of the uplink subframe and downlink subframe of the backhaul link; and

a first controlling unit, configured to configure the downlink subframe of the backhaul link as an MBSFN subframe, and disable scheduling the UE served by the RN to perform uplink data transmission in the uplink subframe of the backhaul link.

The specific working procedure of the system and devices shown in FIGS. 4 to 6 may refer to the description of the method example shown in FIG. 3, and will not be illustrated in detail herein.

In the solution shown in FIGS. 3 to 6, the eNB informs the RN of the allocated uplink subframe for performing uplink transmission of the backhaul link and the allocated downlink subframe for performing downlink transmission of the backhaul link. In this way, in a subsequent procedure, the RN may configure the downlink subframe of the backhaul link as an MBSFN subframe, and disable scheduling the UE served by the RN to perform uplink data transmission in the uplink subframe of the backhaul link, so as to avoid uplink transmission conflict.

However, the above solution has a problem in practical applications, i.e., since the eNB needs to inform the RN of the uplink subframe for performing uplink transmission of the backhaul link and the downlink subframe for performing downlink transmission of the backhaul link, signaling overhead is large, especially in an instance adopting the FDD mode.

Therefore, in the solution of the present invention, the eNB allocates the uplink subframe for performing uplink transmission of the backhaul link and the downlink subframe for performing downlink transmission of the backhaul link, and informs the RN of the allocation information of the uplink subframe or downlink subframe of the backhaul link, so that the RN determines, according to a predefined timing relationship, a downlink subframe or uplink subframe of the backhaul link of which the eNB does not inform.

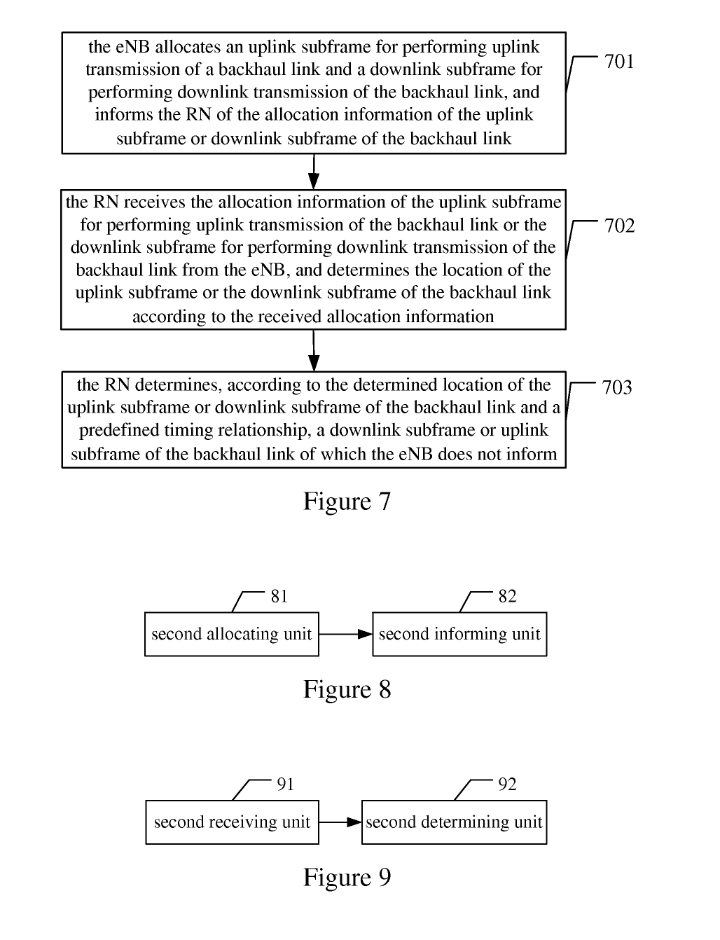

FIG. 7 is a schematic flowchart illustrating a resource scheduling method according to a second example of the present invention. As shown in FIG. 7, the method includes the following steps.

Step 701: the eNB allocates an uplink subframe for performing uplink transmission of a backhaul link and a downlink subframe for performing downlink transmission of the backhaul link, and informs the RN of the allocation information of the uplink subframe or downlink subframe of the backhaul link.

It is a conventional technology that how the eNB allocates the uplink subframe for performing uplink transmission of the backhaul link and the downlink subframe for performing downlink transmission of the backhaul link, and will not be described in detail.

In this example, the eNB only needs to inform the RN of one kind of subframes of the backhaul link, i.e. the eNB only needs to inform the RN of the allocation information of the uplink subframe for performing uplink transmission of the backhaul link or the downlink subframe for performing downlink transmission of the backhaul link. Specifically, the eNB may inform the RN through a higher-layer signaling or a broadcast message. The higher-layer signaling includes, but is not limited to, an RRC signaling.

Step 702: the RN receives the allocation information of the uplink subframe for performing uplink transmission of the backhaul link or the downlink subframe for performing downlink transmission of the backhaul link from the eNB, and determines the location of the uplink subframe or the downlink subframe of the backhaul link according to the received allocation information.

In this example, suppose the eNB informs the RN of the allocation information of the uplink subframe or downlink subframe of the backhaul link through a bitmap mode, the RN may determine that the location corresponding to a bit which is configured as 1 in the bitmap is the location of the uplink subframe or downlink subframe of the backhaul link.

Step 703: the RN determines, according to the determined location of the uplink subframe or downlink subframe of the backhaul link and a predefined timing relationship, a downlink subframe or uplink subframe of the backhaul link of which the eNB does not inform.

The predefined timing relationship mentioned herein includes a Hybrid Automatic Repeat Request (HARQ) timing relationship between a downlink subframe for transmitting uplink scheduling information and a corresponding uplink subframe for transmitting PUSCH, or a HARQ timing relationship between a downlink subframe for transmitting Physical Downlink Shared Channel (PDSCH) and a corresponding uplink subframe for transmitting uplink ACK/NACK, or a HARQ relationship between an uplink subframe for transmitting PUSCH and a corresponding downlink subframe for transmitting downlink ACK/NACK.

In the backhaul link, the uplink scheduling information is transmitted by the eNB in the downlink subframe, and correspondingly, the PUSCH is transmitted by the RN in the uplink subframe. The PDSCH is transmitted by the eNB in the downlink subframe, and correspondingly, the ACK/NACK is transmitted by the eNB in the uplink subframe. The PUSCH is transmitted by the RN in the uplink subframe, and correspondingly, the ACK/NACK is transmitted by the eNB in the downlink subframe.

The above timing relationships have been defined in the prior art, and the following is some examples.

In the FDD mode, if the PDSCH or the PUSCH is transmitted in a subframe n, the ACK/NACK is transmitted in a subframe n+4. If the uplink scheduling information is transmitted in the subframe n, the PUSCH is transmitted in the subframe n+4. That is to say, in the FDD mode, no matter which timing relationship is adopted, the distance between the location of the uplink subframe and the location of the downlink subframe is 4 ms (the length of each subframe is 1 ms). And thus, the RN may determine, according to any one of the above timing relationship, an uplink subframe for performing uplink transmission of the backhaul link or a downlink subframe for performing downlink transmission of the backhaul link of which the eNB does not inform. Generally, subframes 0, 4, 5 and 9 can not be configured as downlink subframes for performing downlink transmission of the backhaul link, i.e. MBSFN subframes.

In the TDD mode, the response location of ACK/NACK and the uplink scheduling location are both related to the uplink and downlink time sequence configuration, for example,

if the ACK/NACK is transmitted in the subframe n, a subframe for transmitting the PDSCH is a subframe n−k, where the value of k is as shown in Table 1.

TABLE 1
a timing relation between ACK/NACK and PDSCH

| Uplink- | | | | | | | | | | |
|---|---|---|---|---|---|---|---|---|---|---|
| Downlink | | | | | | | | | | |
| (UL-DL) | Subframe n | | | | | | | | | |
| Configuration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, 4, 6 | — | — | — | — | 8, 7, | — | — |
| | | | | | | | | 4, 6 | | |
| 3 | — | — | 7, 6, 11 | 6, 5 | 5, 4 | — | — | — | — | — |
| 4 | — | — | 12, 8, 7, 11 | 6, 5, | — | — | — | — | — | — |
| | | | | 4, 7 | | | | | | |
| 5 | — | — | 13, 12, 9, 8, | — | — | — | — | — | — | — |
| | | | 7, 5, 4, 11, 6 | | | | | | | |
| 6 | — | — | 7 | 7 | 5 | — | — | 7 | 7 | — |

If the ACK/NACK is transmitted in a subframe 2, the PDSCH is transmitted in a subframe 2-6 (suppose the configuration mode 0 is adopted), i.e., the PDSCH is transmitted in the sixth subframe of a radio frame before a radio frame where the subframe 2 is located. It should be noted that, Table 1 shows 7 configuration modes (the configuration modes 0 and 5 usually are not used). In practical applications, it can be determined, according to practical requirements, which configuration mode is selected. The subsequent similar instances will not be described in detail.

If the uplink scheduling information is transmitted in the subframe n, a subframe for transmitting the PUSCH, i.e., the scheduled uplink subframe, is n+k. The value of k is as shown in Table 2.

TABLE 2
a timing relation between a downlink subframe for transmitting
uplink scheduling information and a scheduled uplink subframe

| TDD UL/DL | DL subframe n | | | | | | | | | |
|---|---|---|---|---|---|---|---|---|---|---|
| Configuration | 0 | 1 | 2 | 3 | 4 | 5 | 6 | 7 | 8 | 9 |
| 0 | 4 | 6 | | | | 4 | 6 | | | |
| 1 | | 6 | | | 4 | | 6 | | | 4 |
| 2 | | | | 4 | | | | | 4 | |
| 3 | 4 | | | | | | | | 4 | 4 |
| 4 | | | | | | | | | 4 | 4 |
| 5 | | | | | | | | | 4 | |
| 6 | 7 | 7 | | | | 7 | 7 | | | 5 |

If the PUSCH is transmitted in the subframe n, the ACK/NACK is transmitted in the subframe n+k. The value of k is as shown in Table 3.

TABLE 3
a timing relation between PUSCH and ACK/NACK

| TDD UL/DL | UL subframe n | | | | | | | | | |
|---|---|---|---|---|---|---|---|---|---|---|
| Configuration | 0 | 1 | 2 | 3 | 4 | 5 | 6 | 7 | 8 | 9 |
| 0 | | | 4 | 7 | 6 | | | 4 | 7 | 6 |
| 1 | | | 4 | 6 | | | | 4 | 6 | |
| 2 | | | 6 | | | | | 6 | | |
| 3 | | | 6 | 6 | 6 | | | | | |
| 4 | | | 6 | 6 | | | | | | |
| 5 | | | 6 | | | | | | | |
| 6 | | | 4 | 6 | 6 | | | 4 | 7 | |

In this example, one of the above three tables to be used may be stored in the RN, and then the RN searches the table according to the received information, to determine the downlink subframe for performing downlink transmission of the backhaul link or the uplink subframe for performing uplink transmission of the backhaul link.

In the FDD mode, since the distance between the location of uplink subframe and the location of the downlink subframe is fixed, the RN may determine the downlink subframe for performing downlink transmission of the backhaul link of which the eNB does not inform, where the distance between the location of the uplink subframe for performing uplink transmission of the backhaul link of which the eNB informs and the location of the downlink subframe for performing downlink transmission of the backhaul link of which the eNB does not inform is four subframes. Similarly, the RN may determine the uplink subframe for performing uplink transmission of the backhaul link of which the eNB does not inform, where the distance between the location of the downlink subframe for performing downlink transmission of the backhaul link of which the eNB informs and the location of the uplink subframe for performing uplink transmission of the backhaul link of which the eNB does not inform is four subframes.

In the TDD mode, the RN needs to search a specific table to determine the uplink subframe or the downlink subframe. Generally, subframes 0, 1, 5 and 6 can not be configured as downlink subframes for performing downlink transmission of the backhaul link, i.e., MBSFN subframes. After determining the uplink subframe or downlink subframe of the backhaul link of which the eNB informs, the RN searches the selected table, and then determines the downlink subframe or uplink subframe of the backhaul link of which the eNB does not inform.

In the FDD mode, suppose eNB allocates the downlink subframe 3 of each radio frame as the downlink subframe of the backhaul link, it can be determined, according to the HARQ timing relationship, that the subframe 7 of each radio frame is the uplink subframe of the backhaul link. This subframe configuration mode does not influence the HARQ timing relationship of the access link.

In the TDD configuration 1, suppose the eNB allocates the subframe 4 of each radio frame as the downlink subframe of the backhaul link, it can be determined that the subframe 8 of each radio frame is the uplink subframe of the backhaul link according to the HARQ timing relationship between the downlink subframe for transmitting the uplink scheduling information and the uplink subframe for transmitting PUSCH or the HARQ timing relationship between the downlink subframe for transmitting PDSCH and the uplink subframe for transmitting uplink ACK/NACK.

It should be noted that, the uplink and downlink subframe allocation methods in the FDD mode and the TDD mode are only examples, and the specific allocation method includes, but is not limited to, the above two allocation methods.

Based on the above method, the example of the present invention also provides a resource scheduling system, which includes: an eNB, configured to allocate an uplink subframe for performing uplink transmission of a backhaul link and a downlink subframe for performing downlink transmission of the backhaul link, and inform a RN of the allocation information of the uplink subframe or the downlink subframe of the backhaul link; and

the RN, configured to receive the allocation information of the uplink subframe for performing uplink transmission of the backhaul link or the downlink subframe for performing downlink transmission of the backhaul link from the eNB, determine the location of the uplink subframe or the downlink subframe of the backhaul link according to the received allocation information, and determine, according to a predefined timing relationship, a downlink subframe or uplink subframe of the backhaul link of which the eNB does not inform.

FIG. 8 is a schematic diagram illustrating the structure of an eNB according to the second example of the present invention. As shown in FIG. 8, the eNB includes:

a second allocating unit 81, configured to allocate an uplink subframe for performing uplink transmission of a backhaul link and a downlink subframe for performing downlink transmission of the backhaul link;

a second informing unit 82, configured to inform a RN of the allocation information of the uplink subframe or the downlink subframe of the backhaul link, so that the RN determines, according to a predefined timing relationship, a downlink subframe or uplink subframes of the backhaul link of which the eNB does not informs.

FIG. 9 is a schematic diagram illustrating the structure of a RN according to the second example of the present invention. As shown in FIG. 9, the RN includes:

a second receiving unit 91, configured to receive allocation information of an uplink subframe for performing uplink transmission of a backhaul link and a downlink subframes for performing downlink transmission of the backhaul link from an eNB;

a second determining unit 92, configured to determine the location of the uplink subframe and downlink subframe of the backhaul link according to the received allocation information, and determine, according to a predefined timing relationship, a downlink subframe or uplink subframe of the backhaul link of which the eNB does not informs.

In the technical solution as shown in FIGS. 7 to 9, the eNB only informs the RN of the allocated uplink subframe for performing uplink transmission of the backhaul link or the allocated downlink subframe for performing downlink transmission of the backhaul link, and then the RN self-determines, according to the received informing message and the prestored timing relationship, a downlink subframe for performing downlink transmission of the backhaul link or an uplink subframe for performing uplink transmission of the backhaul link of which the eNB does not inform. In this way, the eNB does not need to inform the RN of both the allocated uplink subframe and the allocated downlink subframe at the same time, so as to decrease signaling overhead.

The foregoing is only the preferred examples of the present invention and is not used to limit the protection scope of the present invention. Any modification, equivalent substitution and improvement without departing from the principle of the present invention are within the protection scope of the present invention.

What is claimed is:

1. A resource scheduling method, comprising:
allocating, by a Base Station (BS), an uplink subframe for performing uplink transmission of a backhaul link and a downlink subframe for performing downlink transmission of the backhaul link, and informing a Relay Node (RN) of allocation information of the uplink subframe and the downlink frame of the backhaul link, so that the RN disable scheduling a User Equipment (UE) served by the RN to perform uplink data transmission in the uplink subframe of the backhaul link and configures the downlink subframe of the backhaul link as a Multicast/Broadcast over a Single Frequency Network (MBSFN) subframe.

2. The method of claim 1, wherein informing a RN of allocation information of the uplink subframe and the downlink frame of the backhaul link comprises:
informing, by the BS, the RN of location information of the uplink subframe and the downlink subframe of the backhaul link.

3. The method of claim 1, wherein informing a RN of allocation information of the uplink subframe and the downlink frame of the backhaul link comprises:
when the uplink subframe and the downlink subframe of the backhaul link are a subset of a predefined subframe allocation set, informing, by the BS, the RN of an index value of the uplink subframe and the downlink subframe of the backhaul link in the predefined subframe allocation set.

4. The method of claim 1, wherein informing a RN of allocation information of the uplink subframe and the downlink frame of the backhaul link comprises:
informing, by the BS, the RN of the allocation information of the uplink subframe and the downlink frame of the backhaul link through a higher-layer signaling or a broadcast message.

5. A resource scheduling method, comprising:
receiving, by a Relay Node (RN), allocation information of an uplink subframe for performing uplink transmission of a backhaul link and a downlink subframe for performing downlink transmission of the backhaul link from a Base Station (BS);
determining, location of the uplink subframe and the downlink subframe of the backhaul link according to the allocation information; and
configuring the downlink subframe of the backhaul link as a Multicast/Broadcast over a Single Frequency Network (MBSFN) subframe, and disabling scheduling a User Equipment (UE) served by the RN to perform uplink data transmission in the uplink subframe of the backhaul link.

6. The method of claim 5, wherein receiving, by a RN, allocation information of an uplink subframe for performing uplink transmission of a backhaul link and a downlink subframe for performing downlink transmission of the backhaul link from a BS comprises:
receiving location information of the uplink subframe and the downlink subframe of the backhaul link from the BS.

7. The method of claim 5, wherein receiving, by a RN, allocation information of an uplink subframe for performing uplink transmission of a backhaul link and a downlink subframe for performing downlink transmission of the backhaul link from a BS comprises:
when the uplink subframe and the downlink subframe of the backhaul link are a subset of a predefined subframe allocation set, receiving, by the RN, an index value of the uplink subframe and the downlink subframe of the backhaul link in the predefined subframe allocation set from the BS.

8. The method of claim 5, wherein receiving, by a RN, allocation information of an uplink subframe for performing uplink transmission of a backhaul link and a downlink subframe for performing downlink transmission of the backhaul link from a BS comprises:
receiving, by the RN, the allocation information of the uplink subframe and the downlink frame of the backhaul link which is transmitted by the BS through a higher-layer signaling or a broadcast message.

9. A Base Station (BS), comprising:
a first allocating unit, configured to allocate an uplink subframe for performing uplink transmission of a backhaul link and a downlink subframe for performing downlink transmission of the backhaul link;
a first informing unit, configured to inform a Relay Node (RN) of allocation information of the uplink subframe and the downlink subframe of the backhaul link, so that the RN disables scheduling a User Equipment (UE) served by the RN to perform uplink data transmission in the uplink subframe of the backhaul link, and configures the downlink subframe of the backhaul link as a Multicast/Broadcast over a Single Frequency Network (MBSFN) subframe.

10. A Relay Node (RN), comprising:
a first receiving unit, configured to receive allocation information of an uplink subframe for performing uplink transmission of a backhaul link and a downlink subframe for performing uplink transmission of the backhaul link from a Base Station (BS);
a first determining unit, configured to determine location of the uplink subframe and the downlink subframe of the backhaul link according to the received allocation information; and
a first controlling unit, configured to configure the downlink subframe of the backhaul link as a Multicast/Broadcast over a Single Frequency Network (MBSFN) subframe, and disable scheduling a User Equipment (UE) served by the RN to perform uplink data transmission in the uplink subframe of the backhaul link.

11. A resource scheduling method, comprising:
allocating, by a Base Station (BS), an uplink subframe for performing uplink transmission of a backhaul link and a downlink subframe for performing downlink transmission of the backhaul link, and informing a Relay Node (RN) of allocation information of the uplink subframe or the downlink frame of the backhaul link, so that the RN determines an downlink subframe and an uplink subframe of the backhaul link of which the BS does not inform.

12. The method of claim 11, wherein informing a RN of allocation information of the uplink subframe or the downlink frame of the backhaul link comprises:
informing, by the BS, the RN of the allocation information of the uplink subframe or the downlink frame of the backhaul link through a higher-layer signaling or a broadcast message.

13. A resource scheduling method, comprising:
receiving, by a Relay Node (RN), allocation information of an uplink subframe for performing uplink transmission of a backhaul link or a downlink subframe for performing downlink transmission of the backhaul link from a Base Station (BS), and determining, location of the uplink subframe or the downlink subframe of the backhaul link according to the allocation information;
determining, by the RN, according to the determined uplink subframe or the downlink subframe of the backhaul link and a predefined timing relationship, an uplink subframe or a downlink subframe of the backhaul link of the BS does not inform.

14. The method of claim 13, wherein receiving, by a RN, allocation information of an uplink subframe for performing uplink transmission of a backhaul link or a downlink subframe for performing downlink transmission of the backhaul link from a BS comprises:
receiving, by the RN, the allocation information of the uplink subframe or the downlink frame of the backhaul link which is transmitted by the BS through a higher-layer signaling or a broadcast message.

15. The method of claim 13, wherein the predefined timing relationship comprising:
a Hybrid Automatic Repeat Request (HARQ) timing relationship between a downlink subframe for transmitting uplink scheduling information and an uplink subframe for transmitting Physical Uplink Shared Channel (PUSCH), or
a HARQ timing relationship between a downlink subframe for transmitting Physical Downlink Shared Channel (PDSCH) and an uplink subframe for transmitting uplink ACK/NACK, or
a HARQ timing relation between an uplink subframe for transmitting PUSCH and a downlink subframe for transmitting downlink ACK/NACK.

16. A Base Station (BS), comprising:
a second allocating unit, configured to allocate an uplink subframe for performing uplink transmission of a backhaul link and a downlink subframe for performing downlink transmission of the backhaul link;
a second informing unit, configured to inform a Relay Node (RN) of allocation information of the uplink subframe or the downlink frame of the backhaul link, so that the RN determines, according to a predefined timing relationship, an uplink subframe or a downlink subframe of the backhaul link of which the BS does not inform.

17. A Relay Node (RN), comprising:
a second receiving unit, configured to receive allocation information of an uplink subframe or a downlink frame of a backhaul link from a Base Station (BS);
a second determining unit, configured to determine location of the uplink subframe or the downlink subframe of the backhaul link according to the allocation information, and determine, according to a predefined timing relationship, a downlink subframe or an uplink subframe of the backhaul link of which the BS does not inform.
